(19) United States
(12) Patent Application Publication
(10) Pub. No.: US 2010/0146351 A1
(43) Pub. Date: Jun. 10, 2010

(54) ERROR CORRECTING SCHEME FOR WIRELESS COMMUNICATION

(75) Inventors: Naveen Kumar KAKANI, Irving, TX (US); Jakub MAJKOWSKI, Helsinki (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/328,403

(22) Filed: Dec. 4, 2008

(51) Int. Cl. H04L 1/00; H04W 4/00; G06F 11/00

(52) U.S. Cl. 714/746; 370/329; 714/E11.001

(57) ABSTRACT

A system for implementing self aggregating communication operations. Wireless communication transports may utilize basic radio transmission units for communication (e.g., such as a symbol, groups of symbols, etc.). Radio transmission units may comprise, for example, one or more message packets. The one or more message packets may be added to a radio transmission unit in preparation for wireless transmission. If unused space exists in the radio transmission unit after the one or more packets have been added, copies of the one or more the packets may also be inserted into the radio transmission unit. Any unfilled space remaining in the radio transmission unit that cannot accommodate complete copies of the one or more message packets may be filled utilizing zero padding. Radio transmission units composed in this manner (e.g., including multiple occurrences of each packet) may be deemed “self aggregated.”

### BACKGROUND

1. Field of Invention

Various embodiments of the present invention relate to wireless communication, and in particular, to providing enhanced error correcting abilities for wireless communication.

2. Background

Improvement in wireless communication is not limited strictly to advancements in hardware. In addition to having more and more functionality incorporated into apparatuses, new communication transports, standards, protocols, methodologies are continually being developed. The evolution of both new hardware technology and the manner in which these technologies are employed helps to make sure that apparatuses are not being limited by the features they support. These new communication protocols allow apparatuses to operate at a higher performance level so that these devices may, for example, satisfy the growing demands of the population of users.

The development of more advanced technologies cannot, however, eliminate the various factors that negatively impact communication performance. For example, interference caused by a multitude of environmental conditions not only continues to exist, but will continue to grow as the usage of wireless communication expands. In particular, interference created by electromagnetic field sources will unavoidably become more common in view of the expanding incorporation of electronic technology into everyday applications. Communication occurring on a first channel may even be interrupted by other activities occurring simultaneously in the same device, and therefore, may be considered “self inflicted” when these features operate in unison.

In view of the above, communication enhancements realized from improvements such as increased data rates, larger data throughput, etc. will not necessarily result in improved quality of service (QoS), and without adequate QoS, any improvements in data rate or amount may not manifest in actual practice due to the overhead caused by retransmission. Moreover, improvements in the transmission speed and/or amount of information that can be transmitted may, in actuality, increase the sensitivity of wireless communication to negative environmental influences, regardless of whether interference is caused by other activities operating concurrently in an apparatus or those encountered in the environment surrounding a communication device.

### SUMMARY

Various embodiments of the present invention are directed to at least a method, apparatus and computer program product concerning self aggregating communication operations. Wireless communication transports may utilize basic radio transmission units for communication (e.g., such as a symbol, groups of symbols, etc.). Radio transmission units may comprise, for example, one or more message packets. The one or more message packets may be added to a radio transmission unit in preparation for wireless transmission. If unused space exists in the radio transmission unit after the one or more packets have been added, copies of the one or more the packets may also be inserted into the radio transmission unit. Any unfilled space remaining in the radio transmission unit that cannot accommodate complete copies of the one or more message packets may be filled utilizing zero padding. Radio transmission units composed in this manner (e.g., including multiple occurrences of each packet) may be deemed “self aggregated.”

The copies of each message packet that are included in each radio transmission unit may be utilized, for example, to resolve communication errors without having to retransmit the radio transmission unit, which may result in improved QoS. In accordance with at least one example embodiment of the present invention, errors that occur when reading message packets (e.g., due to corrupt packets) may be resolved by accessing another copy of the message packet included within the same radio transmission unit. Message packets may be organized within radio transmission units in various configurations. For example, each message packet in a radio transmission unit may be followed by one or more copies of the same message packet. Message packets may also be arranged in a repeating sequences, wherein sequences include each message packet that was added to the radio transmission unit. Regardless of the particular structure used, each message packet may include an indicator that the radio transmission unit is self aggregated.

In at least one example implementation, apparatuses that receive self aggregated radio transmission units may attempt to access at least one copy of each message packet therein. If any of the packets are found to contain errors (e.g., are corrupt), a determination may be made as to whether additional copies of corrupt packets exist. This determination may be made, for example, based on an indicator configured in each packet. In radio transmission units that are determined to be self aggregated (e.g., including multiple copies of each message packet), one or more subsequent copies of the message packet that was found to be corrupt may be accessed. For example, each subsequent copy in the radio transmission unit that is provided in the radio transmission unit may be accessed until an intact copy of the message packet is identified.

The above summarized configurations or operations of various embodiments of the present invention have been provided merely for the sake of explanation, and therefore, are not intended to be limiting. Moreover, inventive elements associated herein with a particular example embodiment of the present invention can be used interchangeably with other example embodiments depending, for example, on the manner in which an embodiment is implemented.

### DESCRIPTION OF DRAWINGS

Various embodiments of the present invention will be further understood from the following detailed description including example implementations and/or configurations of the various embodiments when taken in conjunction with appended drawings, in which:

FIG. 1 discloses an example of a computer and communication system with which the various embodiments of the present invention may be enabled or implemented.

FIG. 2 discloses an example scenario that will be utilized to explain the various embodiments of the present invention.

FIG. 3 discloses an example problem scenario that will be utilized to explain the various embodiments of the present invention.

FIG. 4 discloses an example implementation in accordance with at least one embodiment of the present invention.

FIG. 5A discloses an example impact of at least one embodiment of the present invention in a first example scenario.

FIG. 5B discloses an example impact of at least one embodiment of the present invention in a second example scenario.

FIG. 6 discloses an example radio transmission unit and an example bit assignment table in accordance with at least one embodiment of the present invention.

FIG. 7 discloses example radio transmission unit configurations in accordance with at least one embodiment of the present invention.

FIG. 8 discloses a flowchart of example processes in accordance with at least one embodiment of the present invention.

### DESCRIPTION OF EXAMPLE EMBODIMENTS

While the present invention has been described herein in terms of a multitude of example embodiments, various changes or alterations can be made therein without departing from the spirit and scope of the present invention, as set forth in the appended claims.

### I. General System with which Embodiments of the Present Invention May be Implemented

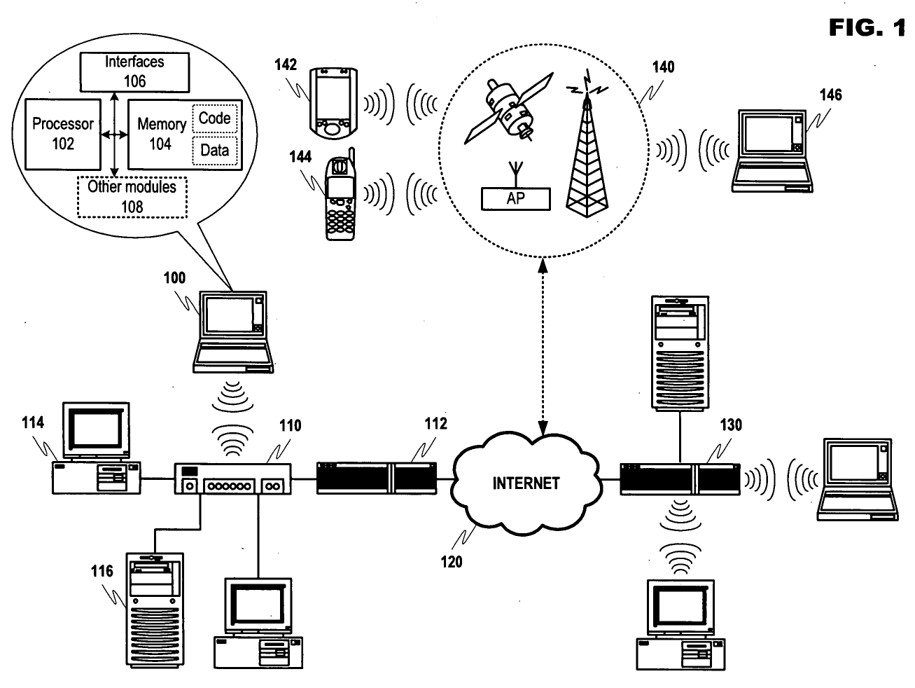

An example of a system that is usable for implementing the various embodiments of the present invention is disclosed in FIG. 1. This system comprises elements that may be included in, or omitted from, a configuration depending, for example, on the requirements of a particular application, and therefore, is not intended to limit present invention in any manner.

Computing device 100 may be, for example, a laptop computer. Elements that represent basic example components comprising functional elements in computing device 100 are disclosed at 102-108. Processor 102 may include one or more devices configured to execute instructions, wherein a group of instructions may be constituted, for example, as program code. In at least one scenario, the execution of program code may include receiving input information from other elements in computing device 100 in order to formulate an output (e.g., data, event, activity, etc). Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 100 may provide wired and/or wireless support to devices such as computer 114 and server 116. Hub 100 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

### II. Example Operational Scenario

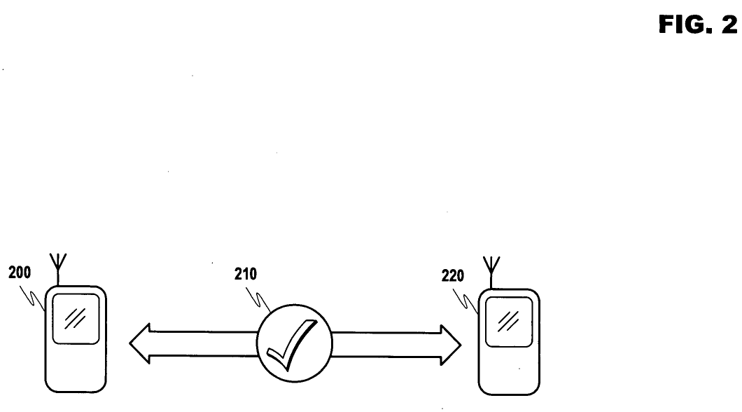

Now referring to FIG. 2, an example scenario comprising two apparatuses that are communicating via wireless communication is disclosed. While only two apparatuses are shown in FIG. 2, the various embodiments of the present invention are not specifically limited to the disclosed interaction that is used only for the sake of explanation herein. In an example “ideal” situation, apparatus 200 and apparatus 220 may communicate via disclosed wireless interaction 210. An interaction may be considered ideal if, for example, no errors occur during wireless interaction 210. Errors may be caused by various internal or external sources of interference. External interference may include electromagnetic fields caused by natural occurrences (e.g., weather), other electronics, etc. Other activities in an apparatus may cause internal interference, such as wireless communication occurring simultaneously via other wireless transports, etc.

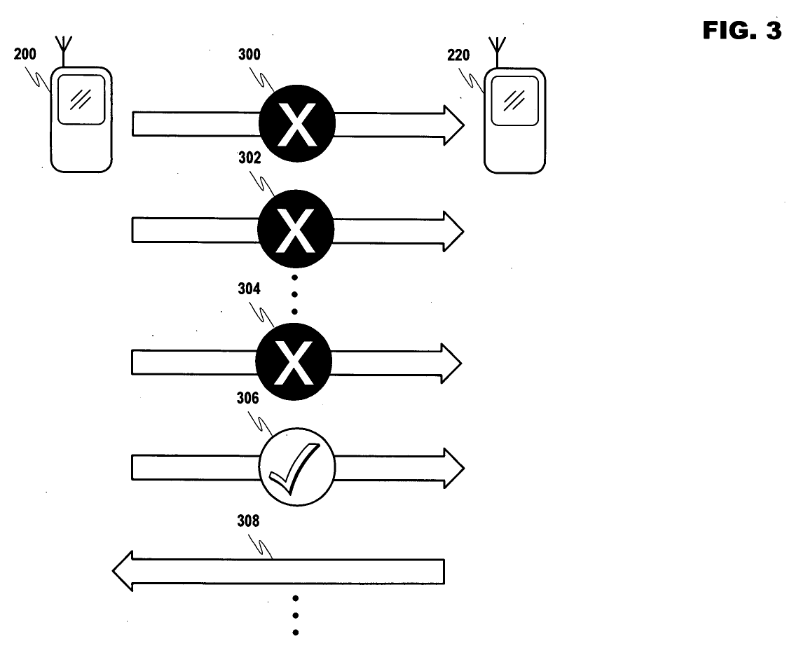

FIG. 3 discloses the potential effect of interference on the example scenario of FIG. 2. Interference with a transmission from apparatus 200 may require retransmission from the apparatus, shown in FIG. 3 at 300-304. Retransmission may continue until a successful transmission occurs. A successful transmission, such as shown at 306 may be acknowledged by apparatus 220 such as shown at 308. The receipt of an acknowledgement sent by apparatus 220 in apparatus 200 may indicate to apparatus 200 that no further retransmissions are necessary. In situations where, for example, the operational environment is expected to be (or is sensed to be) extremely “noisy,” apparatus 200 may further be configured to send a predetermined number of retransmissions in order to account for expected transmission loss. The transmitting apparatus may not require acknowledgement from the receiving apparatus, and may in turn just proceed with the predetermined number of transmissions for the next radio transmission unit. While this “brute-force” strategy may serve to overpower environmental interference, it expends resources at a faster rate, which may be detrimental to resource limited apparatuses. It may further limit the QoS level that is achievable by the apparatus, at least with respect to communication speed.

### III. Examples of Self Aggregation

In accordance with at least one example implementation of the present invention, additional bandwidth that will becoming available in emerging technologies may be used to help alleviate the negative impact of interference on wireless communication. For example, available bandwidth around the millimeter wave (mm-wave) band (e.g., 60 GHz) offers increased capacity for wireless communication. To increase transmission efficiency and combat multipath behavior in millimeter wave band orthogonal frequency division multiplexing (OFDM), apparatuses may be configured to divide substantial bandwidth into multiple orthogonally distributed narrow sub channels. As a result, OFDM may make the transmitted data experience a flat fading channel instead of a frequency selective channel.

The HSI PHY specification from the WPAN 802.15.3c draft comprises 1.7 GHz of bandwidth divided in 512 sub-carriers, of which 336 are data sub-carriers. Modulation schemes that have been considered include QPSK, 16QAM or 64QAM that provide 672, 1344 and 2016 coded bits per radio transmission unit, respectively. Compared to WLAN IEEE 802.11a, which also uses OFDM, the number of coded bits per radio transmission unit in HSI PHY is seven times greater. Even though systems in the mm-wave band are being considered for applications having high bandwidth requirements such as uncompressed video streaming, these systems employ short frames for link control and management purposes such as acknowledgements, RTS/CTS frames or probe requests. These shorter frames introduce system inefficiency as only a small portion of the total available content space in these larger radio transmission units may be used. The amount of unused content space was not as significant a problem in previous systems having smaller bandwidth, and therefore, fewer coded bits per symbol (e.g., WLAN, WPAN).

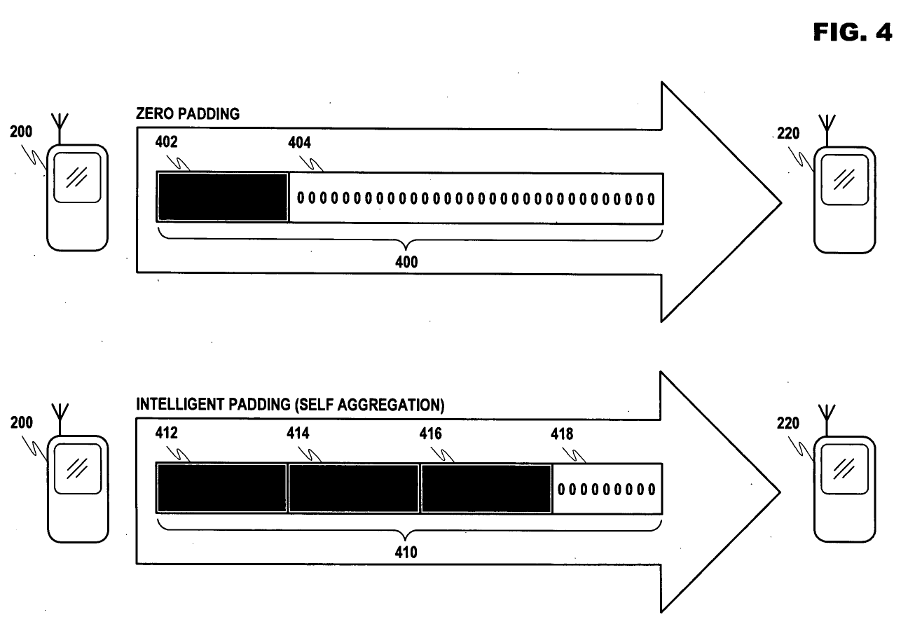

FIG. 4 discloses an example problem scenario and a proposed solution in accordance with at least one example embodiment of the present invention. Although IEEE 802.11n introduced data aggregation mechanisms, limitations in the existing format include, for example, no logic for aggregating multiple copies of a packet, the existing mechanism does not allow for efficient use of that mechanism for other purposes like link adaptation or packet error rate improvement, etc. Additionally, scenarios where small packets are used (e.g., VoIP packets) with high speed radios limit the number of parallel radios that can be used in the device. It may therefore be preferred to have mechanisms that ensure more effective utilization of available resources.

In accordance with at least one embodiment of the present invention, an example self aggregation mechanism that allows aggregation of multiple copies of a packet that is usable, for example, with short packets (e.g., data or control packets that are substantially smaller than the basic radio transmission unit being utilized, the basic radio transmission unit comprising, for example, a symbol, a group of symbols, etc.). As a result, no additional overhead is introduced to the system, but rather “intelligent padding” may be accomplished that maximizes resource usage and provides greater link integrity. FIG. 4 discloses two example transmissions demonstrating the resources that are wasted by transmitting shorter packets utilizing wireless transports having large capacity radio transmission units. Zero padding is demonstrated in radio transmission unit 400 wherein a packet 402 is transmitted from apparatus 200 to apparatus 202. Since packet 402 only occupies a small portion of radio transmission unit 400, the unused portion of radio transmission unit 400 is zero padded as shown at 404. The resulting radio transmission unit 400 goes mostly unused, which results in a waste of available communication resources.

However, radio transmission unit 410 employs intelligent padding in accordance with at least one embodiment of the present invention. Apparatus 200 transmits radio transmission unit 410 including multiple copies of a packet shown at 412-416. Three complete copies of the packet may fit within radio transmission unit 410. The balance of radio transmission unit 410 (e.g., the remaining unused portion in which a complete packet cannot fit) may be completed using zero padding as shown 418. Using a strategy such as shown at 410, the available bandwidth may be utilized efficiently while providing additional features.

Using self aggregation may be considered as a retransmission technique for real time application, like VoIP, where existing ACK mechanisms cannot be used due to tight delay requirements for real time traffic. Moreover, in WLAN and WPAN systems there is typically no retransmission mechanism for control messages. For instance, when an ACK for a data frame is lost, the corresponding data frame has to be retransmitted in entirety even though it was actually received correctly. Allowing self aggregation of an ACK frame in the aforementioned situation may result in various ACK copies within the same radio transmission unit being affected differently by any interference on the channel. As a result, at least one ACK copy in the radio transmission unit may be received fully intact, or alternatively, different intact portions of various corrupt packet copies may be combined to form an error-free copy of the packet.

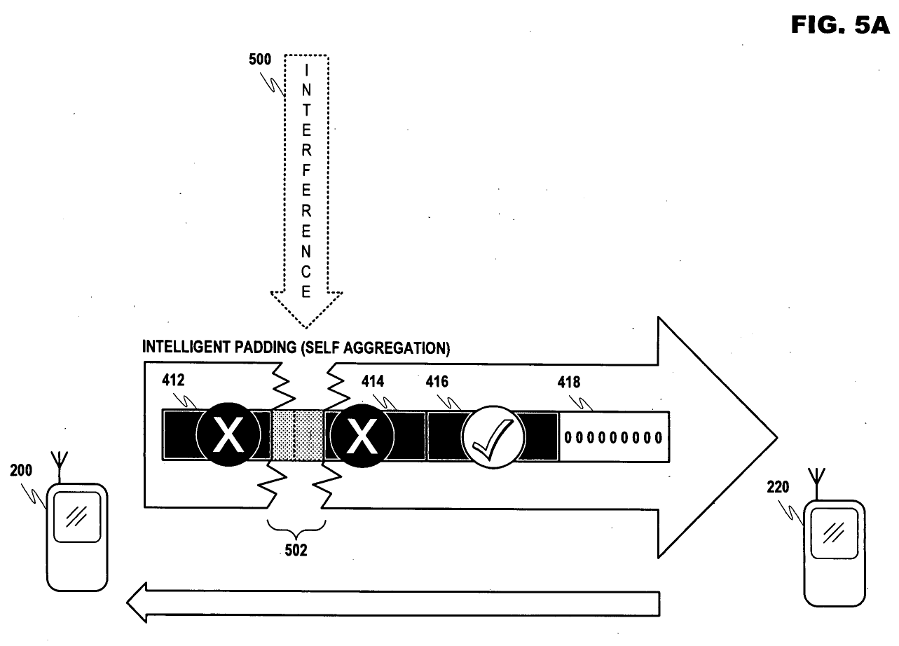

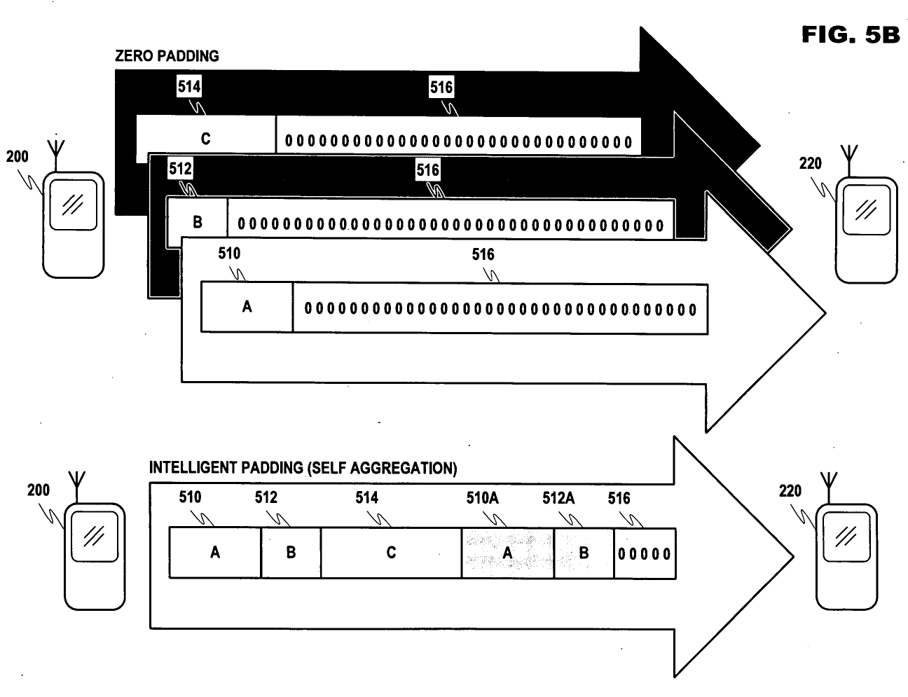

An example utilization of self aggregation to improve QoS, in accordance with at least one embodiment of the present invention, is disclosed with respect to FIG. 5A. Interference 500 may cause packets 412 and 414 in to become corrupted during transmission from apparatus 200 to apparatus 220. The corruption of at least part of packets 412 and 414 is shown at 502. As a result, the contents of packets 412 and 414 will not able to be accessed, and these packets will be deemed corrupt by apparatus 220. However, as packets 412, 414 and 416 are copies of each other, and packet 416 was received intact (e.g., complete and without error), apparatus 220 may access the content of packet 416 in order to obtain the same content that would have been provide by either packet 412 or 414. Providing additional copies of packets in portions of radio transmission unit that would have otherwise gone unused may maximize bandwidth use and improve the overall QoS of the communication.

Another example application to which various embodiments of the present invention may be applied is disclosed in FIG. 5B. Three message packets 510, 512 and 514 may be queued for transmission in apparatus 200. Further, it is possible that message packets 510, 512 and 514 may be of different size, as shown. In determining the order in which the message packets should be transmitted, apparatus 200 may utilize information, including access category information, to formulate a relative priority between the pending data. An access category may, for example, identify a packet as related to a particular application, associate the packet with a particular wireless transport or destination apparatus, may be the oldest packet in a large queue of packets to be sent, etc. In the first example shown in FIG. 5B, message packets 510, 512 and 514 are each sent in separate radio transmission units, wherein the unused space in each radio transmission unit being zero padded as shown at 516. While these message packets may be successfully conveyed to apparatus 220, a substantial amount of available communication bandwidth is wasted in the use of separate radio transmission units that are much larger than the pending message packets 510, 512 and 514, resulting in a large amount of messaging traffic that may, in turn, negatively impact overall QoS.

The total amount of messaging traffic may be reduced by incorporating more than one message packet into each radio transmission unit. In accordance with various embodiments of the present invention, this activity may be provided through self aggregation as shown on the bottom of FIG. 5B. A determination may then be made regarding which, if any, of message packets 510, 512 and 514 can be incorporated into one radio transmission unit, and also if any copies of these packets can be/should be enclosed. All three message packets 510, 512 and 514 will fit into the radio transmission unit shown in FIG. 5B, with unused space sufficient enough to accept at least one packet copy. For example, the radio transmission unit may accommodate message packet copies 510A and 512A (as shown) as a result of determining that insertion of the packet copies 510A and 512A satisfies a criterion related to packet copy insertion. Criteria may include, for example, packet size, type, priority, etc. Any remaining space not large enough to accept copies of message packets may be zero padded at 516. Alternatively, a copy of message packet 514 could have been included in the radio transmission unit instead of 510A and 512A based on, for example, the determination classifying packet 514 as higher priority. Example configurations like FIG. 5B may reduce the amount of messaging required to convey data while providing imbedded error correction, which may result in faster operation and improved QoS.

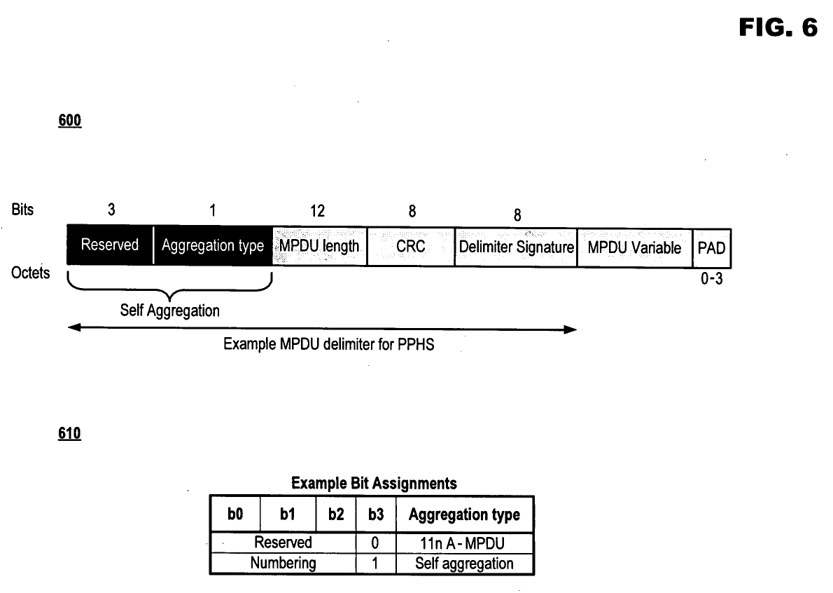

Additionally, using different modulation schemes with different packet copies can provide improvement to link adaptation logic. This may result in much faster link adaptation mechanism when compared to traditional request response scheme. Self aggregation schemes in accordance with various embodiments of the present invention may be implemented in at least two configurations: with PHY preamble and header sharing (PPHS) and with PHY preamble and header sharing and MAC header sharing (PMHS). The first approach with PHY preamble and header sharing may be considered as an improvement over the A-MPDU aggregation mechanism defined in IEEE 802.11n draft. Consequently, reserved bits within the MPDU delimiter of the A-MPDU sub-frame may be used to signal that self aggregation is being utilized, and in addition, a number of multiple copies may be indicated in the radio transmission unit. An example MPDU delimiter for self aggregation is disclosed as part of radio transmission unit 600 in FIG. 6. The first three bits may remain reserved if an aggregation type bit is set to “0”. An example of this relationship is disclosed in the bit assignment table of 610. If an aggregation type bit is set to “1”, then first three bits may be used to indicate, for example, an ordinal number of copies of a packet or an ordinal number of self aggregations within the entire A-MPDU.

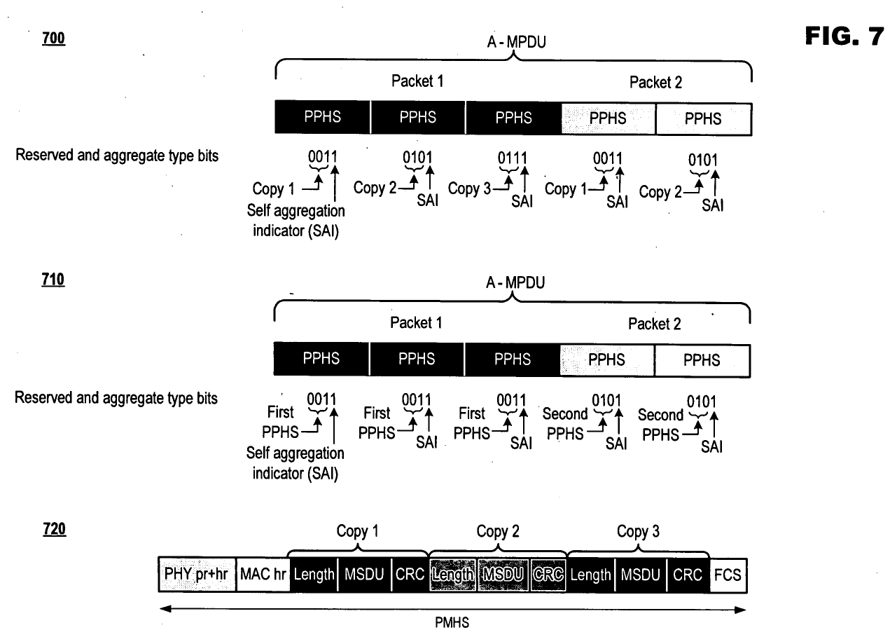

Examples of each of the usage scenarios discussed above are shown in FIG. 7 in the radio transmission units shown at 700, 710 and 720. The advantage of the numbering scheme shown at 710 is that each subsequent PPHS is an exact copy of the previous one, and hence, processing at transmitter side may be reduced. On the contrary, in the example shown at 700 the numbering bits change for each copy in order to reflect relative order of the copies. In case of PMHS approach 720, aggregation overhead may be reduced when compared to PPHS case as only one MAC header is required. This solution may be beneficial for packets that include the frame body (e.g. data frames). However, in order for PMHS schemes to benefit from increased probability of correct transmission due to the provision of multiple copies, each subsequent copy should have its own CRC checksum to identify whether it is erroneous or not, an example of which is shown at 720 in FIG. 7. Copies within the PMHS frame are not numbered because only copies of a single packet can be self aggregated within a PMHS frame.

PMHS 720 may require special processing, as even if the frame checksum (FCS) of a whole frame indicates that the overall frame is erroneous, it should still be forwarded for further processing in order to verify if all the copies are in error. The 802.11 standard does not allow such behavior. Additionally, in order for apparatus 220 to know if a received packet is a PMHS packet or not one bit within the MAC header is used to indicate this feature. With respect to the 802.11n draft, the reserved bit from the HT control field may be used for that purpose.

The number of copies contained within each PPHS or PMHS frame depends on if intelligent padding is done, or required, by PER. In intelligent padding, no additional overhead is introduced by copies of a packet. However, the number of copies may be limited by minimum system resource granularity (e.g., by OFDM radio transmission unit size or minimum transport block size). In situations where target PER copies may depend on minimum system resource granularity, the number of copies, N, can be calculated as N=logPER(PERtarget). However, trade offs between additional overhead and increases in performance should be evaluated before deciding on the number of copies. Multiple copies may expand over the minimum system resource granularity the self aggregation should be restricted to rather small packets as higher probability of collision caused by traffic increase due to multiple copies can offset the gain from diversity.

### IV. Example Process

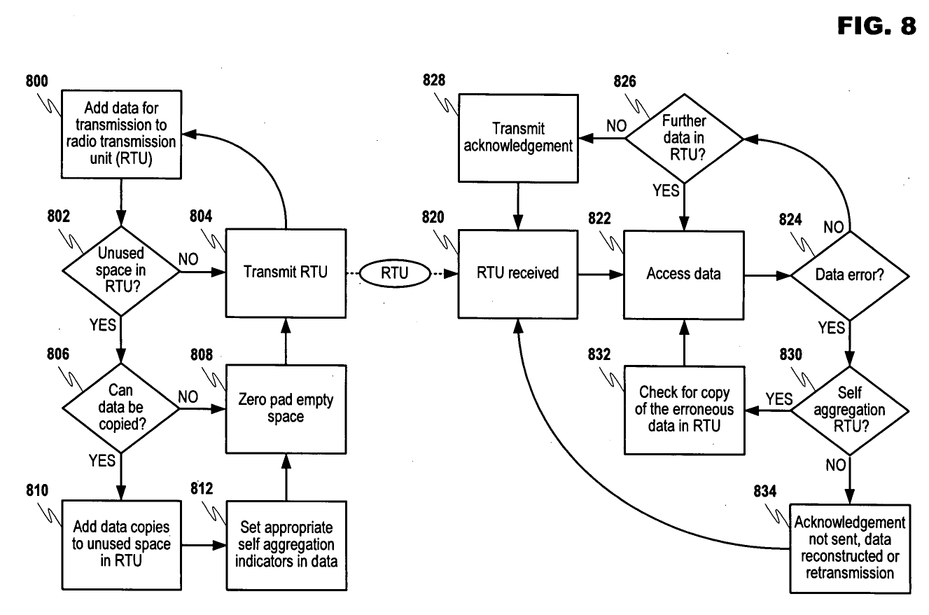

A flowchart of an example process, in accordance with at least one example embodiment of the present invention, is disclosed in FIG. 8. The flowchart of FIG. 8 actually comprises two flowcharts: an example transmitting process in steps 800-812 and an example reception process in steps 820-832. The process may initiate in step 800 wherein one or more message packets are awaiting transmission in an apparatus. The one or more packets awaiting transmission may then be added to a radio transmission unit (RTU), and a determination may then be made in step 802 as to whether any unused space exists in the radio transmission unit. If no unused space remains, then the radio transmission unit may be transmitted in step 804. The process may then return to step 800 to await further message packets for transmission.

If in step 802 unused space is available in the radio transmission unit, a further determination may be made in step 806 as to whether sufficient space remains in which to include message packet copies. If the remaining space is insufficient for one or more packet copies, then in step 808 the remaining space may be filled utilizing zero padding and the radio transmission unit may be transmitted in step 804. Otherwise, in step 810 copies of one or more packets may be inserted into the radio transmission unit. Radio transmission units may include one or more indicators that may be used by receiving apparatuses when making a determination regarding whether error correction via self aggregation is available. An example implementation may include the configuration of indicators in each packet to inform receiving apparatuses that self aggregation data is available (e.g., that copies of at least some of the data provided in the radio transmission unit exist in the same radio transmission unit). Configuring the packet copies may comprise, for example, setting a self aggregation bit or flag in each packet. The unused space remaining after inserting packet copies into a radio transmission unit (e.g., the unused space not large enough to accommodate complete packets) may then be filled using zero padding in step 808, and then in step 804 the data within the radio transmission unit may be transmitted. The process may then return to step 800 to await additional packets for transmission.

The data included within the radio transmission unit may be transmitted from one apparatus (e.g., apparatus 200) to another apparatus (e.g., apparatus 220). Apparatus 200 may receive the data within the radio transmission unit at step 820 and access the content of the data (e.g., one of the one or more packets) in step 822. If no errors are detected in the packet (e.g., the packet is determined to be uncorrupted in step 824), then in step 826 a determination may be made as to whether any packets have not yet been accessed. This determination may include, for example, determining whether the remaining packets that have not yet been accessed in a radio transmission unit are just copies of data that has already been successfully accessed. In such a situation the radio transmission unit may then be discarded (since at least one copy of the entire content of the radio transmission unit has been received intact). If all packets have been accessed, then in step 824 an acknowledgement message indicating that all information in the radio transmission unit has been received successfully may be sent in step 828, and the process may then return to step 820 in order to wait for the next radio transmission unit to be received.

If errors are detected in a packet (step 824), the data within the radio transmission unit may be checked in step 830 in order to determine if self aggregation is implemented. If the radio transmission unit has been configured in a self aggregated format, then in step 832 the radio transmission unit may be checked to determine if further copies of the packet exist. The process may then access any copies of the packet that were found in step 822 and may proceed as previously described above. Otherwise, if no self aggregation has been implemented, the process may proceed to step 834 wherein receipt of the data within the radio transmission unit is not acknowledged. This may further result in corrective action, such as the receiving apparatus attempting to reconstruct the packet using the corrupt copies of the packet, or simply waiting for retransmission of the packet from the source apparatus (e.g., apparatus 200). The process may then return to step 820 to await the reception of further data.

While various exemplary configurations of the present invention have been disclosed above, the present invention is not strictly limited to the previous embodiments.

For example, in accordance with at least one example embodiment, the present invention may include an apparatus comprising: means for determining that data is awaiting transmission; means for inserting the data into a radio transmission unit; means for determining whether unused space exists in the radio transmission unit after the data is inserted; means for determining whether the unused space in the radio transmission unit satisfies a criterion allowing for the insertion of one or more copies of at least part of the data; and means for inserting the one or more copies of at least part of the data into the unused space when it is determined that the unused space satisfies the criterion.

In addition, various example embodiments of the present invention may comprise another apparatus, alone or used in combination with the above apparatus, comprising: means for receiving a radio transmission unit, the radio transmission unit containing data; means for accessing at least part of the data; means for, if the at least part of the data that was accessed contains errors, determining if one or more copies of the at least part of the data exist in the radio transmission unit; and means for, if one or more copies of the at least part of the data exist in the radio transmission unit, accessing at least one further instance of the at least part of the data.

Accordingly, it will be apparent to persons skilled in the relevant art that various changes in form a and detail can be made therein without departing from the spirit and scope of the invention. The breadth and scope of the present invention should not be limited by any of the above-described example embodiments, but should be defined only in accordance with the following claims and their equivalents.

What is claimed:

1. A method, comprising:
determining that data is awaiting transmission;
inserting the data into a radio transmission unit;
determining whether unused space exists in the radio transmission unit after the data is inserted;
determining whether the unused space in the radio transmission unit satisfies a criterion allowing for the insertion of one or more copies of at least part of the data; and
inserting the one or more copies of at least part of the data into the unused space when it is determined that the unused space satisfies the criterion.

2. The method of claim 1, wherein the radio transmission unit is arranged so that the at least part of the data is immediately followed by one or more copies of the at least part of the data.

3. The method of claim 1, wherein the radio transmission unit is arranged in repeating sequences of the at least part of the data.

4. The method of claim 1, wherein link adaptation is improved by utilizing different modulation schemes with the one or more copies of the at least part of the data.

5. The method of claim 1, further comprising configuring an indicator within the radio transmission unit to indicate that one or more copies of the at least part of the data is inserted into the radio transmission unit.

6. A method, comprising:
receiving a radio transmission unit, the radio transmission unit containing data;
accessing at least part of the data;
if the at least part of the data that was accessed contains errors, determining if one or more copies of the at least part of the data exist in the radio transmission unit; and
if one or more copies of the at least part of the data exist in the radio transmission unit, accessing at least one further instance of the at least part of the data.

7. The method of claim 6, wherein determining if one or more copies of the at least part of the data exist in the radio transmission unit comprises determining the configuration of an indicator in the radio transmission unit.

8. The method of claim 6, wherein accessing the content of at least one of the copies comprises accessing a first copy, and if the first copy is determined to have errors, determining if at least one other copy exists and accessing the at least one other copy.

9. The method of claim 6, further comprising discarding the radio transmission unit upon determining that only copies of data that has already been successfully accessed remain.

10. A computer program product comprising computer executable program code recorded on a computer readable medium, comprising:
computer readable program code configured to determine that data is awaiting transmission;
computer readable program code configured to insert the data into a radio transmission unit;
computer readable program code configured to determine whether unused space exists in the radio transmission unit after the data is inserted;
computer readable program code configured to determine whether the unused space in the radio transmission unit satisfies a criterion allowing for the insertion of one or more copies of at least part of the data; and
computer readable program code configured to insert the one or more copies of at least part of the data into the unused space when it is determined that the unused space satisfies the criterion.

11. The computer program product of claim 10, wherein the radio transmission unit is arranged so that the at least part of the data is immediately followed by one or more copies of the at least part of the data.

12. The computer program product of claim 10, wherein the radio transmission unit is arranged in repeating sequences of the at least part of the data.

13. The computer program product of claim 10, wherein link adaptation is improved by utilizing different modulation schemes with the one or more copies of the at least part of the data.

14. The computer program product of claim 10, further comprising configuring an indicator within the radio transmission unit to indicate that one or more copies of the at least part of the data is inserted into the radio transmission unit.

15. A computer program product comprising computer executable program code recorded on a computer readable medium, comprising:
computer readable program code configured to receive a radio transmission unit, the radio transmission unit containing data;
computer readable program code configured to access at least part of the data;
computer readable program code configured to, if the at least part of the data that was accessed contains errors, determining if one or more copies of the at least part of the data exist in the radio transmission unit; and
computer readable program code configured to, if one or more copies of the at least part of the data exist in the radio transmission unit, accessing at least one further instance of the at least part of the data.

16. The computer program product of claim 15, wherein determining if one or more copies of the at least part of the data exist in the radio transmission unit comprises determining the configuration of an indicator in the radio transmission unit.

17. The computer program product of claim 15, wherein accessing the content of at least one of the copies comprises accessing a first copy, and if the first copy is determined to have errors, determining if at least one other copy exists and accessing the at least one other copy.

18. The computer program product of claim 15, further comprising discarding the radio transmission unit upon determining that only copies of data that has already been successfully accessed remain.

19. An apparatus, comprising:
a processor, the processor being configured to:
determine that data is awaiting transmission;
insert the data into a radio transmission unit;
determine whether unused space exists in the radio transmission unit after the data is inserted;
determine whether the unused space in the radio transmission unit satisfies a criterion allowing for the insertion of one or more copies of at least part of the data; and
insert the one or more copies of at least part of the data into the unused space when it is determined that the unused space satisfies the criterion.

20. The apparatus of claim 19, wherein the radio transmission unit is arranged so that the at least part of the data is immediately followed by one or more copies of the at least part of the data.

21. The apparatus of claim 19, wherein the radio transmission unit is arranged in repeating sequences of the at least part of the data.

22. The apparatus of claim 19, wherein link adaptation is improved by utilizing different modulation schemes with the one or more copies of the at least part of the data.

23. The apparatus of claim 19, further comprising configuring an indicator within the radio transmission unit to indicate that one or more copies of the at least part of the data is inserted into the radio transmission unit.

24. An apparatus, comprising:
A processor, the processor being configured to:
receive a radio transmission unit, the radio transmission unit containing data;
access at least part of the data;
if the at least part of the data that was accessed contains errors, determine if one or more copies of the at least part of the data exist in the radio transmission unit; and
if one or more copies of the at least part of the data exist in the radio transmission unit, access at least one further instance of the at least part of the data.

25. The apparatus of claim 24, wherein determining if one or more copies of the at least part of the data exist in the radio transmission unit comprises determining the configuration of an indicator in the radio transmission unit.

26. The apparatus of claim 24, wherein accessing the content of at least one of the copies comprises accessing a first copy, and if the first copy is determined to have errors, determining if at least one other copy exists and accessing the at least one other copy.

27. The apparatus of claim 24, further comprising discarding the radio transmission unit upon determining that only copies of data that has already been successfully accessed remain.
